(19) United States
(12) Patent Application Publication
(10) Pub. No.: US 2011/0182383 A1
(43) Pub. Date: Jul. 28, 2011

(54) Template-based Estimation of Frequency Spectra

(76) Inventor: Subburajan Ponnuswamy, Cupertino, CA (US)

(21) Appl. No.: 12/695,017

(22) Filed: Jan. 27, 2010

(51) Int. Cl. H04L 27/00

(52) U.S. Cl. 375/316

(57) ABSTRACT

Estimating frequency spectrum for digital signals. A frequency spectrum for a digital signal is estimated using a stored template. A frame is received by a receiver on the network. A template is selected from a group of templates based on the received signal parameters, which may include modulation and coding, duration, channel and channel bandwidth, preamble type, beam-forming information, source identifier, and PHY rate. There may be a template for each combination, or a template for a set of related signal types. The template amplitude is scaled based on the signal strength of the received signal to create an estimate of the frequency spectrum, and may also be scaled on duration. The templates may be generated for example to represent IEEE 802.11 transmission modes and rates. Each template represents a frequency spectrum, as an example a FFT spectrum, taken at a specific signal strength. The duration of the frame is later used to calculate the spectrum duty cycle. Spectrum estimation may be performed on the receiver or the device hosting the receiver, with the estimated spectrum sent to a monitoring host, or the signal parameters, strength, and duration may be sent to the monitoring host where spectrum estimation is performed.

### BACKGROUND OF THE INVENTION

The present invention relates to digital networks, and in particular, to the problem of estimating frequency spectra of transmitted digital signals.

Wireless digital networks are becoming ubiquitous in enterprises, providing secure and cost-effective access to resources. In evaluating and diagnosing the operation of such networks, various measurement tools are used. One set of tools measures quantities such as signal strengths over time; the signals being measured may be signals carrying information, or they may be from interfering devices. Receivers associated with the network, such as access points (APs) and in client devices such as laptops, handheld devices, plug-in cards, and the like allow the monitoring and reporting of time-domain information such as the aggregate received signal strength indicator (RSSI) or Signal-to-Noise Ratio (SNR) as a single value for the entire frame.

Another set of tools measures quantities such as peak signal strength, bandwidth, and other frequency-domain information including signal strength variation over frequency. Spectrum analyzers are the preeminent tool for displaying signals in this manner.

In wireless networks, dedicated spectrum monitor (SM) devices are often placed in the network to perform traditional spectrum analyzer like functions in standalone mode or over a network, where a SM may be designed to collect and report raw or normalized amplitude-versus-frequency data for activity on monitored frequencies. If the SM is also configured to act as a wireless access point or wireless client, the SM may not be able to collect amplitude-versus-frequency data for modulated wireless signals as it is required to decode these wireless signals in order to support access point or client functions. In the access point or client mode or configuration of operation, these devices are often only able to report RSSI or similar signal strength information on the wireless signals they are receiving, in addition to other information such as duration, frame length, modulation and quality of the frames. The same receiver in access point or client mode may or may not be able to collect amplitude-versus-frequency data for non-wireless signals such as interference or other wireless signals that cannot be decoded by this radio.

In producing frequency spectrum displays, the frequency-domain data from spectrum monitors which is in amplitude-versus-frequency form must be combined with the time-domain information either from the same receiver or another receiver, which only consists of an aggregate RSSI or similar signal strength information along with other information characterizing the received frame.

Wired digital networks, such as cable television networks, also carry a plurality of digital signals on different frequency channels, and have many of the same issues.

What is needed is a way to estimate frequency spectra of digital signals.

### BRIEF DESCRIPTION OF THE DRAWINGS

The invention may be best understood by referring to the following description and accompanying drawings that are used to illustrate embodiments of the invention in which:

FIG. 1 shows a wireless network.

### DETAILED DESCRIPTION

Embodiments of the invention relate to methods of estimating frequency spectra of signals in a digital network. While the invention is described herein in terms of IEEE 802.11 signals and wireless networks, the techniques are equally applicable to other digital systems and networks including but not limited to cable modems, WiMAX, Bluetooth, and 3G/4G.

According to the invention, a receiver associated with the network estimates the spectrum of a received signal. In the reception process, the receiver has not only a signal strength indication, such as RSSI or SNR, but also a set of parameters characterizing the signal type. For IEEE 802.11 wireless signals, the parameters may include modulation and coding, duration, channel and channel bandwidth, preamble type, beam-forming information, source identifier and PHY rate. A set of pre-defined spectrum templates are provided, corresponding to supported signal types. A template is chosen to match the received signal, scaled in amplitude according to the received signal level, and scaled in time by the duration of the received signal to form an estimated spectrum. This estimation process may be performed at the device containing the receiver, or the estimation process may be performed at another location based on the signal type, received amplitude, and duration.

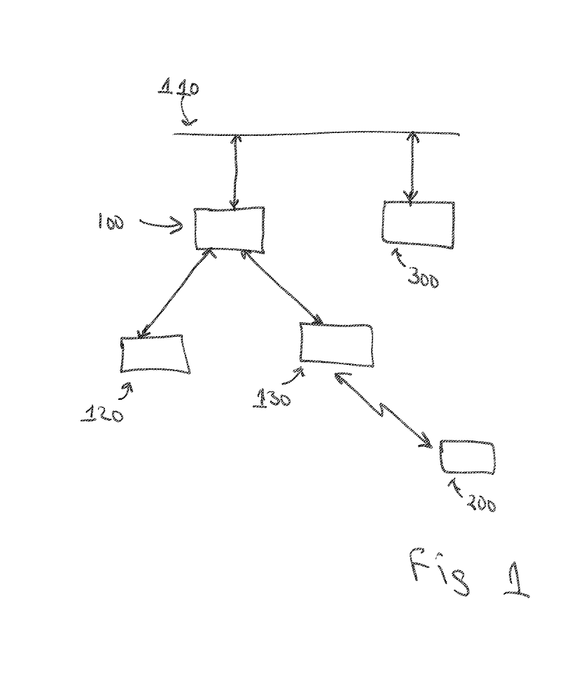

FIG. 1 shows a network in which controller 100 connects to wired network 110. In one embodiment of the invention, controller 100 supports spectrum monitor 120 and access point 130. Client device 200 connects through access point 130. Also present connected to network 110 is monitoring host 300. Multiple spectrum monitors 120 and multiple access points 130 may be present.

As is known to the art, controller 100, spectrum monitor 120, and access point 130 are purpose-built digital devices, each containing a processor, memory hierarchy, and input/output interfaces. Processors used generally include MIPS class processors, as well as processors from companies such as Cavium, Intel, AMD, and Acorn. The memory hierarchy typically includes fast read-write memory such as DRAM for device operation, and non-volatile memory such as Flash for file storage and device startup. Controller 100, spectrum monitor 120, and access points 130 typically operate under the control of an operating system such as Linux or other real-time capable system.

Controller 100 typically has a plurality of wired interfaces, such as IEEE802.3 Ethernet interfaces. Spectrum monitors 120 and access points 130 typically have at least one wired interface, such as an IEEE802.3 wired Ethernet interface. Both spectrum monitors and access points contain receivers for receiving signals, such as IEEE802.11 wireless signals. Multiple receivers may be present, for the same band, or for multiple bands. As an example, receivers may be provided for both 2.4 GHz and 5 GHz bands. These may be provided in the form of radio modules containing receivers, transmitters, and modulation/demodulation subsystems.

Client device 200 may be a wireless device such as a portable computer, or other wireless device with wireless connectivity. Such devices also contain a processor, memory hierarchy, and input/output interfaces. Wireless interfaces are commonly IEEE802.11 interfaces, commonly built around radio modules containing receivers, transmitters, and modulation/demodulation subsystems.

Monitoring host 300 may be a dedicated computer system, or it may be a process running in another system such as controller 100, or on a wireless client 200 such as laptop computer. Again, as understood by the art, such systems contain a processor, memory hierarchy, and input/output interfaces.

As is known to the art, a spectrum monitor may be a special-purpose device, or it may be a re-purposed access point. Depending on the implementation, it may be possible to switch a unit between spectrum monitor operation and access point operation under remote control, for example through control commands, or by restarting the unit with different software.

Client device 200 connects to access point 130 using a wireless interface, for example, and IEEE802.11 wireless interface. This interface contains both a receiver and a transmitter. As with access points 130, the wireless interface may be provided in the form of a radio module containing receiver, transmitter, and modulation/demodulation subsystems.

According to the invention, a receiver associated with the network estimates the spectrum of a received signal. This receiver may be in an access point 130 or in a client device 200. In the reception process, the receiver has not only a signal strength indication, such as RSSI or SNR, but also a set of parameters characterizing the signal type. For IEEE 802.11 wireless signals, the parameters may include modulation and coding, duration, channel and channel bandwidth, preamble type, beam-forming information, source identifier and PHY rate.

For example, IEEE 802.11a, 802.11g and 802.11n standards define PHY rates from 6 Mbps to 600 Mbps. Data rates of 6 and 9 Mbps use BPSK modulation. Data rates of 12 and 18 Mbps use QPSK modulation. Data rates of 24 and 36 Mbps use 16-QAM modulation, and 48 and 54 Mbps use 64-QAM modulation. For 802.11n signals, the signals may be transmitted over a 20 MHz or 40 MHz channel depending on the modulation and coding rate. Each of these PHY rates and modulation types will have a different characteristic frequency spectrum around a predetermined carrier frequency.

As a further example, wired systems using DOCSIS standards, such as on cable television networks, use 64-QAM or 256-QAM for downstream data, and QPSK, 16-QAM, 32-QAM, 64-QAM, or 128-QAM modulation for upstream data. Data channels are grouped to fit into the cable television spectrum.

According to the invention, a set of predefined spectral templates are provided, corresponding to the supported signal types (signal modulation, coding, channel width, preamble-type, and PHY rate). The templates may resemble FFT spectra of the corresponding signal types. There may be a specific template for each possible combination, or a template for a set of related signal types. A template is selected based on the time-domain characteristics of the received wireless signal. The spectrum associated with the selected template is scaled in amplitude and duration by the received signal strength and duration to form an estimated spectrum. The templates may be stored in a channel-independent manner or offset by the frequency of the channel. This offset may be from the channel center frequency, which is preferred, a channel edge frequency, or other convenient point used across a band of interest. As is known to the art, channels 1 through 14 in the 2.4 GHz Wi-Fi band range in center frequency from 2.412 GHz for channel 1 to 2.484 GHz for channel 14. Different channels are authorized for use in different countries.

The spectrum estimation process may be performed in a receiver associated with the network, such as an access point 130 in a wireless network, or a cable modem in a cable network, with the receiver sending the estimated spectrum to a monitoring host 300 on the network or a monitoring process on the same device, or the spectrum estimation process may be performed at a monitoring host 300, with the receiver sending information on the signal characteristics (signal modulation, coding, channel and channel width, preamble-type, and PHY rate) and signal strength to the monitoring host.

In another embodiment of the invention, the data needed to reproduce a scaled template may be time-stamped and stored, such as for replay or analysis at a later time. The stored data may include time, signal characteristics, signal strength and duration. Subsets of the data may be stored; since many parameters are used to select a template, retaining only the selected template, time, channel, amplitude, and duration may be sufficient for many applications.

In one embodiment of the invention, templates are stored using a logarithmic scale for signal strength in dBm, prescaled to a predetermined reference level. Use of a logarithmic scale for signal strength allows scaling of the template by the received signal strength to be done with simple addition and subtraction. Signal duration may also be used to calculate duty cycle of each frequency bin or the entire channel or band.

Templates for the various signal types may be prepared by capturing sample and controlled transmissions of the various signals by a spectrum monitor or spectrum analyzer. In some embodiments it may be useful to capture templates using antennas and a receiver chain similar to or the same as that used by the receiver so that the overall response is similar. In another embodiment of the invention, differences in responses among different types of receivers may be compensated for by using separate sets of templates for different receivers, such as access points, receivers used in laptops, plug-in cards, and so on. In yet another embodiment of the invention, differences in transmitter signal characteristics may also be accurately captured on the spectrum display by using unique samples based on a source identifier, such as MAC OUI.

A stored template contains sufficient information to select and display the appropriate frequency domain sample. A template may be characterized by the source, modulation and coding, aggregate signal strength or RSSI, channel width, start/end frequency, center frequency or channel number, preamble-type, beam-forming information and duration in addition to other physical layer or media-access layer parameters. The template data consisting of amplitude-versus-frequency is stored in the form of frequency bins, where each frequency bin corresponds to a specific width indicating the maximum resolution supported by the spectrum monitor. For example, if the maximum resolution supported by the spectrum monitor is 156.25 KHz and if the template is for a 20 MHz signal, 128 frequency bins are stored, where each bin will correspond to a frequency width of 156.25 KHz and consist of an amplitude value. If the spectrum monitor supports variable resolution, lower resolutions may be obtained by combining multiple frequency bins.

At the monitoring host, estimated spectra from one or more receivers may be combined with other spectra to form an estimated spectrum covering multiple channels, or an entire band or any frequency range of interest. Spectral data may be combined from multiple receivers as well as from spectrum monitors deployed on the network. The monitoring host may be queried to display the spectrum for portions of a band, one or more channels, or an entire band. Such displays may be assembled from measured spectra collected from spectrum monitors as well as estimated spectra from one or more receivers.

As is known to the art, the present invention may be realized in hardware, software, or a combination of hardware and software. The present invention may be realized in a centralized fashion in one computer system, or in a distributed fashion where different elements are spread across several interconnected computer systems associated with the network. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method of estimating the frequency spectrum of a signal received over a digital network comprising:
receiving a signal on a receiver associated with the digital network,
measuring the strength of the received signal,
identifying the signal type of the received signal,
selecting from a set of predefined spectrum templates a template based on the signal type of the received signal, and
scaling the selected template in amplitude by the strength of the received signal.

2. The method of claim 1 further including the steps of:
measuring the duration of the received signal, and
scaling the selected template in duration by the duration of the received signal.

3. The method of claim 1 where the steps of:
receiving a signal,
measuring the strength of the received signal, and
identifying the signal type of the received signal,
are performed on a first device on the digital network, which sends at least the signal type and signal strength to a second device on the digital network where the steps of:
selecting from a set of predefined spectrum templates a template based on the signal type of the received signal, and
scaling the selected template in amplitude by the strength of the received signal are performed.

4. The method of claim 3 where the steps of receiving the signal, measuring the strength of the signal, and identifying the signal type of the received signal includes the steps of measuring the duration of the signal and recording a time stamp for the received signal.

5. A machine readable medium having a set of instructions stored therein, which when executed on a on a processor causes a set of operations to be performed comprising:
receiving a signal on a receiver associated with the digital network,
measuring the strength of the received signal,
measuring the duration of the received signal,
identifying the signal type of the received signal,
selecting from a set of predefined spectrum templates a template based on the signal type of the received signal, and
scaling the selected template in amplitude by the strength of the received signal and in duration by the duration of the received signal.

6. The machine readable medium of claim 5 where portions of the set of instructions are performed on a first processor embedded in a receiver associated with a first device on a digital network, and portions of the set of instructions are performed on a second device on the digital network.
